(19) United States
(12) Patent Application Publication
(10) Pub. No.: US 2005/0163151 A1
(43) Pub. Date: Jul. 28, 2005

(54) Projectile having a casing and/or interior acting as a communication bus between electronic components

(75) Inventors: Dennis Dean Ferguson, Austin, TX (US); Gary Benton McMillian, Austin, TX (US)

Correspondence Address: Thomas Spinelli, 2 Sipala Court, East Northport, NY, 11731, US

(73) Assignee: Omnitek Partners LLC

(21) Appl. No.: 11/080,260

(22) Filed: Mar. 15, 2005

Related U.S. Application Data
(63) Continuation-in-part of application No. 10/638,996, filed on Aug. 12, 2003, now Pat. No. 6,892,644.

(51) Int. Cl. H04L 12/42; H04L 12/403; H04L 12/28

(52) U.S. Cl. 370/449

(57) ABSTRACT

A method for communicating data in a network including a controlling node and a plurality of non-controlling nodes is provided. The method including: said controlling node sequentially polling each of said plurality of non-controlling nodes in said network to grant access to said network to allow a transfer of data to another one of said plurality of non-controlling nodes which may be stored at one or more of said plurality of non-controlling nodes; responding to said grant access at each of said plurality of non-controlling nodes with an indication of denial or acceptance; transmitting to another one of said plurality of non-controlling nodes, at least a portion of said data which may be stored at said one or more of said plurality of non-controlling nodes in the case where said response to said grant access is acceptance; and repeating the above acts in a cyclical manner.

### CROSS-REFERENCE TO RELATED APPLICATION

This application is a Continuation-In-Part application of U.S. application Ser. No. 10/638,996 filed on Aug. 12, 2003, the entire contents of which is incorporated herein by reference.

### BACKGROUND OF THE INVENTION

1. Field of the Invention

The present invention relates generally to projectiles, and more particularly, to projectiles having a casing and/or interior that act as a communication bus between at least two components of the projectile. For purposes of this disclosure, a projectile is any flying object, such as munitions, rockets, or aircraft. Also for purposes of this disclosure, a communication bus is anything that transmits one or more signals between two or more components. Such transmission may be one-way or two-way. Thus, the transmission may be a simple point-to-point link between two components or a point to many links between several components. Furthermore, the transmission may be such that the transmitted signal(s) are available to any components on the communication bus. Still further, the communication bus may be more than one media, such as a waveguide, potting material, and/or free space in the casing (including the casing itself).

2. Prior Art

Projectiles typically have a casing or shell in which electronic/electrical components are housed. The electronic/electrical (collectively referred to hereinafter as “electronic” or “electronics”) components communicate with each other and/or other devices via internal wiring (which includes printed circuit boards). While the wiring has its advantages, it suffers from certain disadvantages such as susceptibility to noise, brittleness, potential for high bit error, takes up a large amount of space in the interior of the casing or shell, can be fragile particularly when subjected to high-g loads, and can suffer from poor connections. In addition, the process of projectile assembly with wiring is cumbersome and time consuming, thereby costly, particularly since in general, numerous components have to be assembled into relatively small spaces. These disadvantages are amplified in certain devices that house electronic components and operate in harsh environments and under high accelerations.

### SUMMARY OF THE INVENTION

It is an object of the present invention to provide a projectile that overcomes the disadvantages of the wiring used to link components in projectiles having electronic components.

Accordingly, an optical wireless communications network protocol for use in low latency, deterministic environments is provided. The protocol employs a hybrid (star/mesh) architecture in which a controller node coordinates communications in a star fashion between data nodes that communicate in a mesh network. The controller node ensures positive handoff in all node-to-node communications such that one node cannot dominate the network and further ensures that any node-to-node communication that requires deterministic timing can be met with timing certainty.

Advantages of embodiments of the OWC network protocol include robustness, low cost and improved performance in low latency deterministic operating environments that demand timing certainty. Low cost and improved reliability is achieved through the use of “off-the-shelf” optical transceivers which significantly improves EMI performance as compared with wired approaches. Low cost may also be achieved, in one embodiment, through the use of the structural elements of a munitions as a transmission media (i.e., optical waveguide). The network is deterministic by virtue of network design and a-priori knowledge of key parameters prior to the time of assembly of the munitions.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a partial sectional view of a nose portion of a projectile according to an embodiment of the present invention.

FIG. 2 illustrates a partial sectional view of a nose of a projectile according to another embodiment of the present invention.

FIG. 3 illustrates a schematic electrical diagram of an infrared (IR) transceiver for use with the projectile of FIG. 2.

FIG. 4 illustrates a projectile according to another embodiment of the present invention.

FIG. 5 illustrates a network embodiment in which inventive concepts of the optical wireless communications (OWC) network protocol may be implemented.

FIG. 6 illustrates operational steps in flow diagram form of an embodiment of a method for performing sequential grant access in accordance with the OWC network protocol

FIG. 7 illustrates an OWC packet structure according to an embodiment.

### DETAILED DESCRIPTION OF THE PREFERRED EMBODIMENT

Although the invention is particularly suited to infra-red or optical signal communication between electronic components, such is discussed by way of example only. Those skilled in the art will appreciate that other communication means can also be utilized, such as ultrasound.

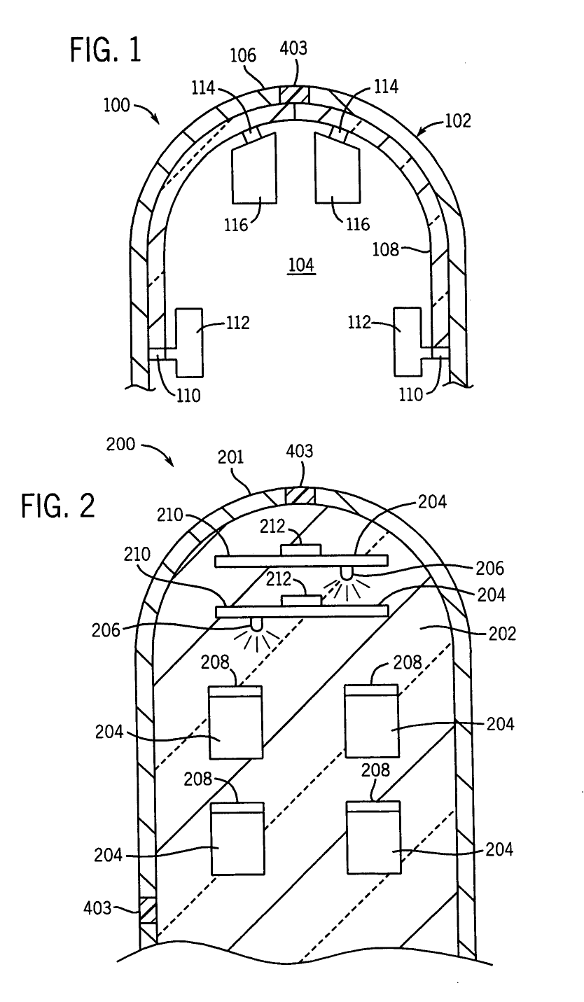

Referring now to FIG. 1, there is shown a partial sectional view of a nose section of a projectile 100. The projectile has a shell 102 that defines an interior 104. The shell preferably has a metal or composite outer portion 106 and an inner waveguide portion 108. The inner waveguide portion 108 is preferably optical glass having appropriate cladding as is known in the art, however, other at least partially transparent materials such as plastics capable of transmitting a signal can also be utilized, such as clear epoxies. The waveguide portion 108 can be disposed on the entire inner surface of the outer portion 106 or only a portion thereof, such as a strip. Alternatively, the waveguide portion 108 can make up the entire shell 102 (no outer portion 106 is used). Still further the waveguide portion 108 can be disposed in strips which can be formed on an inner surface of the casing 102 or in channels (not shown) formed on the inner surface of the casing 102, such as that disclosed in co-pending U.S. application Ser. No. 10/639,001, filed on the same day herewith and entitled Device Having A Casing and/or an Interior Acting As A Communication Bus Between Electronic Components, the entire contents of which is incorporated herein by its reference. For purposes of this disclosure, “casing” includes not only the shell of the projectile but the internal space therein.

At least one transmitter 110 is arranged on the waveguide portion 108 or proximate thereto such that an optical signal can be transmitted to the waveguide portion 108. The transmitter 110 can be integral with a corresponding electronic component 112 or connected thereto. At another location on the waveguide portion 108 are located detectors 114 for detecting the optical signals in the waveguide portion 108. Each detector 114 is either integral with or connected to another electronic/electrical component 116. Thus, those skilled in the art will appreciate that any component can communicate with another component through the waveguide portion 108, which acts as a communication bus. Of course, each of the components can have both a transmitter 110 and detector 114 such that a two-way communication can be achieved. Although not shown, multiplexers and demultiplexers can be used such that certain components can operate at selected frequencies and/or wavelengths and not interfere with other components on the bus. The components, such as the transmitter 110 and detector 114 can be fastened to the waveguide portion 108 in a number of ways, such as those also disclosed in co-pending U.S. application Ser. No. 10/639,001, filed on the same day herewith) entitled Device Having A Casing Acting As A Communication Bus Between Electronic Components, the entire contents of which has incorporated herein by its reference.

Those skilled in the art will also appreciate that the interior is not cluttered with components and internal wiring resulting in more components being able to occupy a given interior size or the projectile 100 being made smaller than a conventional projectile having the same number of internal components. Other advantages include:

*The optical transmission provides robust, interference free channels between physically disconnected components/systems;

*The optical transmission is naturally resistant to very high g-loads and harsh environments;

*For shorter distances between the transmitter and receiver encountered in projectiles, the system is inexpensive and an extremely low bit rate error (better than 10⁻¹²) can be readily achieved; and

*Eliminates the need for wires and related problems and space requirements.

*Ease of assembly because two parts can be attached or even screwed together easily, which is very difficult with wires running from one part to the other.

Alternatively, ultrasound can be used to communicate between the internal components. In which case, the shell or a portion thereof needs to be able to carry an ultrasound signal between components. Such a shell, or portion thereof, may be constructed from a suitable metal. In the case of ultrasound, an ultrasonic generator is used to place signals on the “bus” (shell) and a corresponding ultrasonic detector detects the ultrasonic signals and relays them to an appropriate component. As discussed above with regard to the optical signal configuration, each component can have both an ultrasonic generator and detector such that two-way communication between components is possible and multiplexers and demultiplexers can be utilized such that certain components can operate at selected frequencies and/or wavelengths and not interfere with other components on the bus.

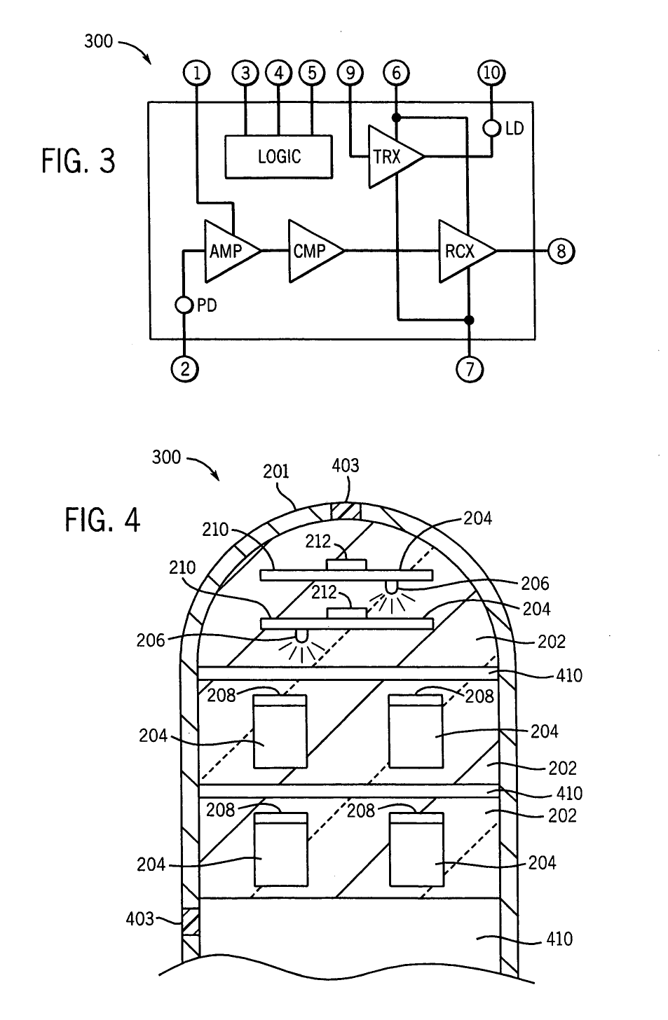

Referring now to FIGS. 2 and 3, another embodiment of a projectile is shown, the projectile being referred to generally by reference numeral 200. Typically, electrical/electronic components of projectiles are encased in a potting material, such as an epoxy, to harden the components against noise and shock due to the high acceleration and/or impact experienced by the projectiles. In the embodiment of FIGS. 2 and 3, the potting material 202, which can be a solid, such as an epoxy, a gel, or a liquid is disposed within a casing 201 of the projectile and is used as a communication bus between electrical/electronic components 204. The communication can be wholly within the potting material 202 or may be partially within the potting material 202 and partially in free space. The communication through the potting material is carried out with a transmitter 206, which outputs any wavelength radiation that can propagate through the potting material 202 and be detected by a receiver 208. It is preferred that the potting material 202 be a solid, such as an epoxy to provide hardening of the projectile to shock and noise and it is further preferred that the radiation used as a communication medium is IR energy, preferably from a IR diode. In such an example, the epoxy need not be transparent or substantially transparent as long as it can carry an IR signal over a required distance, such as several hundred mm or less. An example of such an epoxy is Dolphon® CC-1024-A Low Viscosity Potting and Casting Epoxy Resin with RE-2000 Reactor mixed at a ratio of 10 parts resin to 1 part reactor, each of which is distributed by John C. Dolph Company. The same epoxy resin and reactor can be used for the waveguide portion 108 discussed above with regard to FIG. 1.

IR technology is well known in the art, particularly in the art of remote control of electronic consumer goods. The IR data association (IrDA®) has standards for communicating data via short-range infrared transmission. Transmission rates fall within three broad categories SIR, MIR and FIR, SIR (Serial Infrared) speeds cover transmission speeds normally supported by an RS-232 port. MIR (Medium Infrared) usually refers to speeds of 0.576 Mb/s to 1.152 Mb/s. FIR (Fast Infrared) denotes transmission speeds of about 4 Mb/s. The standard has been modified for faster transmission speeds up to 16 Mb/s (referred to as very fast Infrared VFIR). Although not preferred, visible light, for example from a laser diode, may also be used to transmit communication signals through the potting material 202.

The transmitters 206 may be carried on printed circuit boards 210 which may also be encased in the potting material 202 or disposed freely throughout the potting material 202. The printed circuit boards each 210 preferably carry their own power supply, such as a battery 212 to eliminate internal wiring. Alternatively, the batteries may be charged as discussed below through the casing 201 by directing energy into the casing 201 with a charging cap. Each of the electronic/electrical components 204 has a receiver 208 for communicating with the transmitters 206. As discussed above with regard to the first embodiment, each of the electrical/electronic components 204 preferably have a receiver 208 and a transmitter 206 such that they can carry out a two-way communication. An example of such a transceiver module 300 is shown in the schematic diagram of FIG. 3. FIG. 3 shows an (IrDA®) transceiver manufactured by Sharp Inc. (2P2W1001YP) which is relatively inexpensive and contains a high speed, high efficiency low power consumption light emitting diode (LD), a silicon PIN photodiode (PD) and a low power bipolar integrated circuit. The circuit contains an LED driver (TRX) and a receiver circuit (RCX) that delivers 4 Mb/s operation for distances of 1 meter. The LED emitter transmits at a nominal wavelength of 880 nm with a radiant intensity in the range of 100 to 500 mW.sr⁻¹, with a radiation angle of +/−15 degrees. The pin photodiode has an integrated amplifier (AMP) and comparator (CMP), which provide a fixed voltage output over a broad range of input optical power levels and data rates. The same or similar transceiver module 300 can also be used for the other embodiments described above with regard to FIG. 1.

The casing 102 can also be provided with a window portion 403, as shown in FIGS. 1 and 2, which can be used to upload or input data or instructions into components of the projectile through the waveguide portion 108 or potting material 202. In a preferred implementation, the window portion 403 is in optical communication with the waveguide portion 108 or potting material 202 and transmits any input signals to the appropriate components on the interior of the projectile. Although described in terms of a transparent window 403 and signal, the input signal can be any signal that propagates through the waveguide portion 108 or potting material 202, such as an IR or ultrasound signal. Furthermore, the window 403 does not have to be a transparent window but merely a portion of the shell, which is capable of transmitting a signal from the exterior of the projectile to one or more components on the interior of the projectile. Although the window 403 is shown on the tip of the nose and on a lower side of the casing, those skilled in the art will appreciate that the window 403 may be located anywhere on the casing of the projectile.

The window 403 can also be utilized to partially power a capacitor, rechargeable battery, or electric power storage device in the interior of the projectile, particularly for the purpose of transmitting required data. Thus, a power storage device can be charged, at least partially, thru the window 403 to enable transfer of data. The charging signal transmitted through the window may be modulated to transmit data as well.

Referring now to FIG. 4, there is shown a projectile according to another embodiment of the present invention, in which similar reference numerals from FIG. 2 denote similar features, the projectile of FIG. 4 being referred to generally by reference numeral 300. FIG. 4 is similar to that of FIG. 2 with the exception that the potting material does not have to completely encase a portion of the projectile's interior. The interior of the projectile includes portions of free space 410 (which may be filled with air or other gases or may be evacuated. Although all of the components 204, 208 are shown encased in the potting material 202, they can also be provided in the free space 410 or partially in the free space 410. Thus, the communication between components is not only through the potting material 202 but can also be done through the free space 410 inside the projectile. The embodiment of FIG. 4 is particularly suitable for wireless sensor communication where the use of wire harnesses is highly cumbersome and expensive and subject to harsh environments. One can, for example send a signal from a sensor mounted on one part of a component to another without wires and without generating RF noise.

Before addressing characteristics of an optical wireless communications (OWC) network protocol of the present invention, implementation aspects will first be addressed, such as those described above (i.e., projectile).

The network in which the OWC network protocol operates includes a group of nodes interconnected by a transmission medium. In a preferred embodiment, the term “node” refers to the various electronic/electrical components in a projectile (i.e., munitions) having a casing housing, as described above. The transmission medium that links each node in the network comprises at least a portion of the projectile casing, as described above. Signals transmitted over the transmission medium in accordance with the OWC protocol may be transmitted, for example, as optical signals or RF signals. The network nodes may have a capability for signal transmission and reception (e.g., a control processor), signal transmission (e.g., a guidance processor) or signal reception (e.g., actuator).

OWC Network Protocol Overview

The OWC network protocol is intended as a robust, low cost, optical network for deterministic network and point-to-point communication suitable for use in both commercial and non-commercial environments. Typical commercial environments may include, without limitation, cell phones and computers that employ an optical network upon which electronic components are connected, such as those disclosed in co-pending U.S. application Ser. No. 10/639,001 filed on Aug. 12, 2003, the entire contents of which is incorporated herein by reference. Military environments include, for example, control applications that support internal communications within the confines of a munition (projectile), as described above. The OWC network protocol is ideally, but not exclusively, suited to an internal munitions environment in that the network protocol is deterministic and the network includes a limited number of nodes. As will be described below, the deterministic nature of the OWC network protocol is a function of the network design and apriori knowledge of key parameters prior to the assembly of the munitions.

The OWC network protocol is ideally suited to support internal communications within the confines of a munition for a number of reasons including, low cost, a capability of meeting the performance constraints of the environment, improved reliability and usability and robustness. Low cost is achieved through the use of “off the shelf” IrDA optical transceivers in addition to utilizing the structural elements within the munition as an optical waveguide. Improved network performance is achieved by virtue of exploiting the small physical size of the network as compared with most other networks. Improved reliability and usability is achieved through the use of optical transceivers as compared to wiring harnesses in a high “g” environment. Network robustness is achieved in the OWC network protocol by virtue of its simplicity and error recovery schemes.

OWC Physical Layer

In one embodiment, the OWC physical layer utilizes low cost “off-the-shelf” IrDA optical transceivers and a custom MAC chip as interfaces to the respective nodes. As is well known, IrDA optical transceivers employ infrared ports and are used in a wide variety of devices ranging from personal computers, printers to mobile phones. The Infrared ports of such devices comply with specifications defined by the Infrared Data Association (IrDA). One benefit of using low cost optical transceivers which replace the traditional wiring harnesses is that the low cost optical transceivers significantly improves the EMI performance. In certain embodiments, optical transceivers having characteristics different than the characteristics of the IrDA optical transceiver may be used. Certain embodiments may also utilize RF transceivers.

OWC MAC Layer

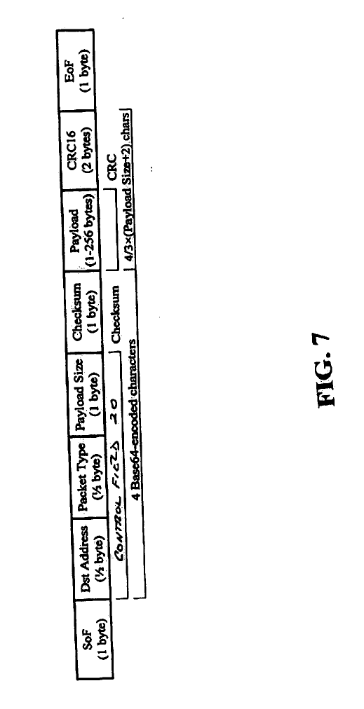

The OWC MAC layer runs above the OWC Physical layer and is configured to construct OWC packets, such as the one described in FIG. 7 below.

OWC Network

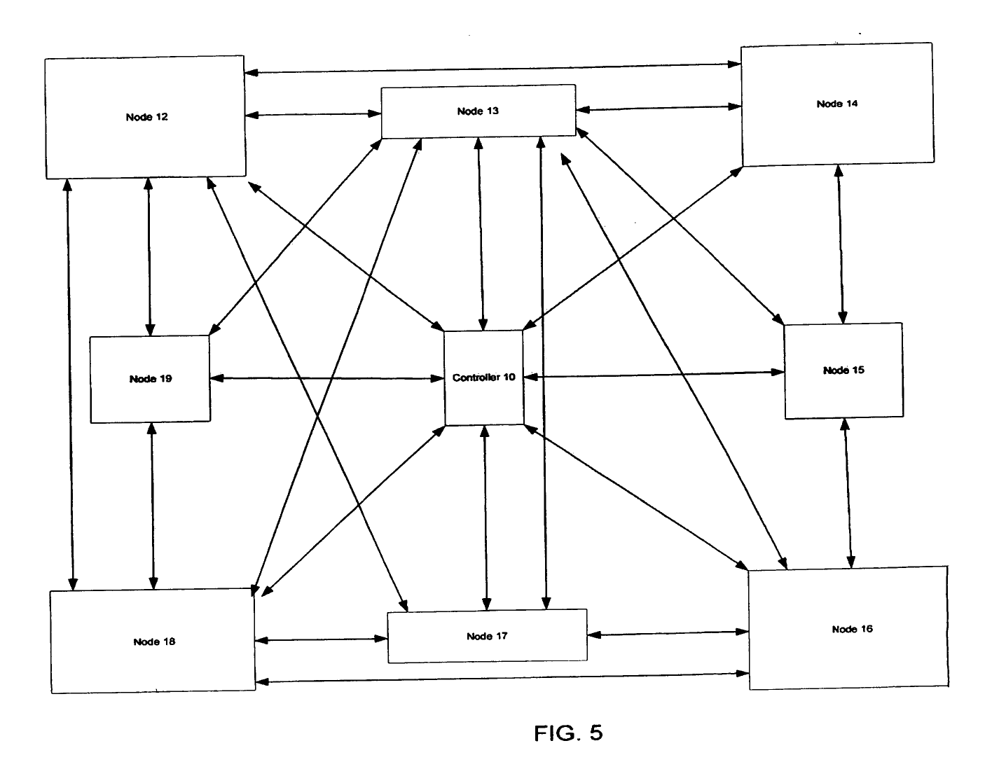

Referring now to FIG. 5, an OWC network 500 in which the OWC network protocol may be implemented is illustrated, wherein, for example, a controller 10 is configured to “grant” access to respective network nodes 12-19 in a sequential cyclical manner to allow the network nodes 12-19 to carry out node-to-node communications on an as need basis. The various network nodes 12-19 may represent, for example, actuator nodes, sub-processor nodes, sensor nodes and central processor nodes.

In an embodiment, the OWC network protocol supports a 16 node address space. Higher address spaces may be supported in applications that accommodate higher data rates.

In the embodiment, a 16 node address space results from the use of the IrDA optical transceivers and a small media access control (MAC) chip as interfaces to the respective nodes (12-19). In the most recent generation of IrDA transceivers, IrDA defines data rates at either 4 MB/s or 16 MB/s. It is well known that the address space can be any power of 2, i.e., 2^{N}, for N=1, 2, 3, and so on. For example, for N=3, the address space is 8 nodes and for N=4, the address space is 16 nodes. In the preferred embodiment, 16 nodes in combination with an IrDA data rate of 16 MB/s provides the best allocation of bandwidth amongst the 16 nodes. However, this combination also limits the maximum data rate for node-to-node communications to 16 MB/s.

In the embodiment, the 16 node address space may be configured in different ways. One way of configuring the 16 node address space is to utilize a single controller and up to 15 non-controller nodes. FIG. 5 illustrates the use of a single controller 10 and eight non-controller nodes, labeled 12-19, respectively. Alternatively, the network can be configured with up to fourteen non-controller nodes and a fifteenth node acting as a broadcast node, assigned to broadcast to all other nodes and create subnets for sub-grouping of nodes.

The network topology of FIG. 5 is a hybrid network 500 that includes features or characteristics of both a star network and a mesh network, both of which are well known to persons skilled in the art. Each node in a mesh network is connected to one or more other nodes. This feature is shown in the hybrid network 500 of FIG. 5. That is, each node (12-19) is connected to the rest of the network 500 by one or more links. The network topology of FIG. 5 also includes features of a star network by virtue of the controller 10 which “grants” access to the respective non-controller nodes 12-19 in the network. Granting access to the respective nodes is akin to token passing in a ring network.

Sequential Grant Access Protocol

Sequential grant access protocol is a feature of the OWC network protocol for determining the sequence or order and manner by which the controller 10 polls the respective network nodes (12-19) to grant access to the network 500.

In operation, the controller 10 sequentially polls the respective network nodes 12-19 in a pre-determined sequence to grant the nodes 12-19 access to the network to conduct node-to-node data communications with another node in the network 500. The controller 10 uses a control message to grant such access. The “access grant” is the mechanism used by the controller 10 to poll or query each network node to determine whether a node 12-19 has a need to communicate data to another node 12-19 in the network 500. It should be understood that the grant process occurs with a much higher frequency than the nodes need to communicate.

The polling sequence is determined prior to system operation, during a system configuration stage, at which time the controller 10 constructs a “grant” list. The “grant” list is a list of the polling order of nodes to be performed in a sequential cyclical manner. An exemplary “grant” list which may be constructed by the controller 10 for the hybrid network 500 of FIG. 5 is:
Grant list={13, 18, 15, 12, 20, 19, 14, 17, 16}

In the exemplary “grant” list shown, controller 10 polls the respective network nodes in the order shown to determine whether each node (12-19) has a need to communicate data to another node in the network 500.

A polled node may respond to the “grant” access offered by the controller 10 in two ways. One possible response of the polled node is to deny the “grant access” offered by the controller 10. In this case, the polled node responds to the “grant” access by sending back, for example, a “NAK” message to the controller 10. A denial occurs when a polled node does not have a need to transmit data to another node in the network 500 at the specific point in time that the “grant access” was received from the controller 10. Upon receiving a denial to the “grant access” at the controller 10, the controller 10 then proceeds to poll the next node in the “grant” list. The second possible response from the polled node to a “grant access” offered by the controller 10 is to accept the “grant access”. In this case, the polled node has a need to transmit data to another node in the network 500 and responds to the “grant” access with an acknowledgement accepting the grant access, such as, for example, an “ACK” message.

Flow Diagram

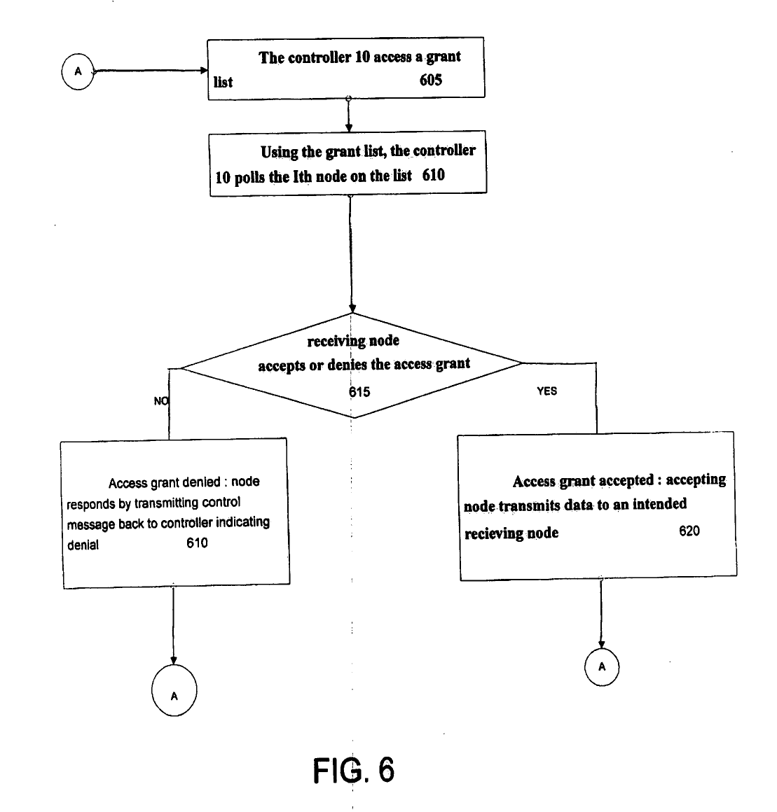

Referring now to FIG. 6, there is shown an overview of operational steps in flow diagram form, of a method for performing sequential grant access in accordance with the OWC network protocol

At activity 605, the controller 10 accesses a grant list created during a system configuration stage.

At activity 610, the controller 10 polls an I^{th} non-controlling node (where I=1 to # nodes in the grant list) to provide “grant access” to the I^{th} non-controlling node to allow or permit the I^{th} non-controlling node to transmit data to an intended receiving node in the network 500.

At activity 615, it is determined whether the I^{th} non-controlling node accepts or denies the “grant access” provided by the controller 10.

At activity 620, when it is determined that the I^{th} non-controlling node denies the “grant access”, the I^{th} non-controlling node responds by transmitting a control message back to the controller 10 indicating denial of the “grant access” (see Table III, control message—0×03). The process then returns to activity 610.

At activity 625, when it is determined that the I^{th} non-controlling node accepts the “grant access”, the I^{th} non-controlling node begins to transmit a data packet to an intended destination node in the network 500. It should be understood that the data packets are constructed from the buffer contents prior to the non-controlling accepting a grant access.

Deterministic Protocol

The amount of data that the controller 10 permits to be transmitted across the network by a node receiving a “grant access” is a function of both the latency requirements of the intended receiving node and a parameter referred to herein as a “grant increment”, to be described as follows

The OWC network protocol of the invention is a deterministic protocol that strictly defines the amount of data that a node may transmit whenever the node accepts a “grant access” from the controller 10.

The deterministic protocol differs from so-called ‘ad-hoc’ protocols, such as used in the Internet, in that ‘ad-hoc’ protocols do not demand a guaranteed latency in communications between nodes. Deterministic protocols, by contrast, demand timing certainty. To achieve such timing certainty in the OWC network of the invention, certain parameters are established during system configuration.

A first parameter established during system configuration, directed towards achieving timing certainty relates to bandwidth allocation. Specifically, during system configuration, each node in the network 500 is allocated a fixed percentage or slice of the overall fixed network bandwidth based on that nodes estimated data transmission needs. For example, in many munition applications there can be a large difference in the data transmission requirements for different node elements. In a munitions application, an imaging sensor, for example, might need to send 1 MB/s whereas a control actuator might only require 5 kB/s or 10 kB/s. Bandwidth allocation is a desirable feature which overcomes limitations that are characteristic of most ‘ad-hoc” networks, such as the Internet. A drawback of networks, such as the Internet, is that the node requiring large bandwidth can completely dominate the network's resources, making it impossible for the lower bandwidth nodes to gain the access they need in a timely fashion. The OWCM protocol of the invention is designed such that large bandwidth nodes can meet their data requirements, but not at the expense of low bandwidth nodes.

Table I illustrates, by way of example, how the total fixed network bandwidth may be allocated among the various nodes 12-19 in the network 500 of FIG. 5. For ease of explanation, it is assumed that the total fixed bandwidth available is 10 MB/s

TABLE I

| | | Allocation |
|---|---|---|
| Node | BW Allocation (%) | amount |
| 12 | 5% | 0.5 MB/s |
| 13 | 14% | 1.4 MB/s |
| 14 | 3% | 0.3 MB/s |
| 15 | 2% | 0.2 MB/s |
| 16 | 9% | 0.9 MB/s |
| 17 | 16% | 1.6 MB/s |
| 18 | 11% | 1.1 MB/s |
| 19 | 8% | 0.8 MB/s |
| 20 | 5% | 0.5 MB/s |
| Extra BW | 27% | 2.8 MB/s |

As shown in Table I, the node's data transmission needs are estimated during system configuration. It should be appreciated that once the respective bandwidth allocations are determined, a node may not thereafter borrow bandwidth from another node. However, as shown in the last row of Table I, the system typically includes extra unaccounted for bandwidth (i.e., slack) which may, in certain embodiments, be borrowed by a node when its instantaneous transmission needs exceeds its pre-determined bandwidth allocation. Further, in the occurrence that a network node fails, for whatever reason, its bandwidth allocation may be dynamically re-allocated to one or more network “live” nodes based on a pre-defined re-allocation scheme established during system configuration.
Grant Increment

A second parameter directed towards achieving timing certainty relates to, what is referred to herein as a “grant increment”. A “grant increment” is a system parameter created during system configuration that defines the amount of bandwidth that will be made available to each node to perform a data communication with another node at a particular polling interval in response to a “grant access” provided by the controller 10. It should be understood that while each node is allocated some percentage of the total bandwidth as defined above (bandwidth allocation), at each polling interval, the amount of data that a node may transmit to another node in response to a “grant increment” is bound by the “grant increment” parameter value, as will be described below. In other words, the “grant increment” parameter is the limiting factor in determining the amount of data that may be transmitted at a particular polling interval, independent of the bandwidth allocation for the transmitting node.

The grant increment parameter value is preferably calculated by dividing the fixed overall network bandwidth by a divisor that is typically on the order of 10 times the number of nodes in the network. By way of example, for the exemplary network of FIG. 5, the fixed overall bandwidth is assumed to be 10 MB/which is divided by 10 times the number of network nodes 8, i.e. 80 to derive a grant increment parameter value of 125 kb/s as shown in equation [1].
Grant increment=(10 MB/s)/(80)=125 kb/s [1]

It should be appreciated that there is flexibility in determining what value to use in the denominator of equation [1].

In operation, the controller 10 sequentially polls the network nodes to offer “grant” accesses in accordance with the sequential grant access protocol described above. Whenever a node accepts a “grant access”, that node is permitted to transfer data to another node in the network. The amount of data the node is permitted to transfer in response to the “grant access” is defined by the “grant increment” parameter value. For example, if a node wishes to transmit 540 kb/s of data to another node, upon receiving a “grant access” from the controller 10, the node may transmit 125 kb/s (the grant increment) of the 540 kb/s to be transferred. A single data transfer of 125 kb/s represents approximately 23% of the 540 kb/s of data to be transferred. The remainder of data is transferred in response to one or more subsequent “grant accesses” from the controller. It should be understood that subsequent grant accesses enabling transfer of the remaining data may occur in the same cycle of operation or over multiple cycles of operation as determined by the “grant” list. This is illustrated by way of example as follows.

Grant list “A” illustrates an exemplary grant list that offers node 12 three consecutive grant accesses in each cycle of operation. Assuming, for example, that node 12 needs to transfer 540 kb/s of data, 375 kb/s of data can be transferred in three consecutive grant accesses, where each grant access permits the transfer of 125 kb/s of data in accordance with a grant increment parameter value of 125 kb/s.
Grant list “A”={13, 18, 15, 12, 12, 12, 20, 19, 14, 17, 16}

In this case, node 12 would wait for the next cycle of operation to transfer any remaining data.

By contrast, grant list “B” illustrates an exemplary grant list that offers node 12 one grant access in each cycle of operation. Therefore, assuming that node 12 needs to transfer the same 540 kb/s of data, 125 kb/s of data can be transferred in each cycle of operation. As such, node 12 requires at least 5 cycles of operation to transfer the entire 540 kb/s of data.
Grant list “B”={13, 18, 15, 12, 20, 19, 14, 17, 16}
The number of grant accesses offered to a node in a single cycle of operation depends upon a number of factors including, without limitation, the latency requirements of an intended receiving node, signal priority and error recovery.

The controller 10 is configured to calculate, during system configuration, with a high degree of certainty, the number of grant accesses required to transmit each nodes entire data payload. Using the instant example, for a data transmission requirement of 540 kb/s, the controller 10 calculates apriori that 5 data “grant” accesses are required at a minimum to transmit the 540 kb/s given a grant increment value of 125 kb/s. While the data requirements of each node is known beforehand with some certainty, the system includes provisions for making dynamic reconfiguration changes during operation in the event of unforeseen occurrences such as damage to a node.

Overall Packet Structure

The format or structure of packets used to formulate the signaling protocol implemented by the present invention are presented below. It should be understood that the protocol is extensible and different packet structures are within contemplation of the invention. The OWC packet structure are labeled as, or divided into, different “packet types” in terms of their function in the overall packet structure (e.g., commands, data, checksums, start/stop packets). As will be readily apparent, the packets may have pre-selected lengths or have variable or dynamically changeable lengths depending upon their respective functions. The packets could also bear differing names, although the same function is still realized, as can occur when protocols are changed during acceptance into a standard. The bytes or byte values used in the various packets are configured as multi-bit (8- or 16-bit) unsigned integers. A summary of the packets being employed along with their byte-count is shown in Table II.

TABLE II

| Packet Name | Number of Bytes |
|---|---|
| Start of Frame (SOF) | 1 |
| Destination Address (Dst Address) | ½ |
| Packet Type | ½ |
| Payload Size | 1 |
| Checksum | 1 |
| Payload | 1-256 |
| CRC16 | 2 |
| End of Frame (EoF) | 1 |

FIG. 7 is an illustration of the OWC packet structure 700 according to one embodiment. All bits between the SoF and EoF are modulo 4 Base64 encoded using a 4/3 substitution table. Base64 encoding enables the SoF and EoF to be unique and provides additional error detection above what is provided by the CRC16 error correction coding. As is well known, Base64 encoding increases the number of bits transmitted by 4/3. This results in 7 bytes (56 bits) for the minimum packet size and 350 bytes (2800 bits) for the maximum packet size. The packet bits are Manchester encoded with a “1” represented by an optical “on to off” transition and a “0” represented by an optical “off to on” transition. Each optical pulse lasts for ½ a bit period. The receiving node's timing is derived from the Manchester encoded signal.

Each of the fields of the OWC packet structure 300 are defined as follows:

1) Start of Frame (SoF) field—consists of the bit sequence “0000 0010” (or 0×02 in hex). The SoF field enables receiving nodes to align their timing and prepare for the remaining packet bits in the packet structure. It should be understood that that network timing is determined by the “grant” allocation process. Network timing occurs on several different levels. A fundamental network timing issue is to synchronize bit timing at each receiving node. Because the OWC protocol is a wireless protocol, there is no opportunity to send a wired “clock” signal to each node. As such, the “clock” for synchronizing the network timing must be included as part of the transmitted signal. In other words, each node adjusts its internal timing to the bit level transitions of the optically encoded bit transitions of the SoF field of the optical signal being transmitted. It should be understood that while the OWC packet structure is optically encoded prior to transmission over the OWC network 500, the bit level transitions referred to are bit level transitions after the optical signal is received at a receiving node and converted into an electrical signal at the receiving node. The “low to high” and “high to low” transitions of the electrical signal become the mechanism for aligning the internal clock signals of the respective nodes.

2) Destination Address (Dst Address)—each node in the network is given a unique node address consisting of four bits, which corresponds to 1 of 15 specific nodes and a controller node. The address 0×00 is typically given to the controller, however, it is not mandatory to do so. Further, in certain embodiments that do not utilize a controller, a single address (e.g., 0×0F) can be assigned or designated as an all nodes address.

3) Packet Type—the OWC packet structure defines six packet types that may be encoded into the 4 bit (½ byte) packet type field. Five of the six packet types consist of control functions and the sixth consists of a data packet. Table III describes the various packet types

TABLE III

| | | Function | |
|---|---|---|---|
| Code | Function | Description | Payload Size |
| 0x01 | Grant | | 0 |
| 0x02 | Decline | | 0 |
| 0x03 | Control | | 1 control byte |
| 0x04 | Data | A data packet | 1-256 bytes |
| 0x05 | ACK | | 0 |
| 0x06 | NAK | Inappropriate | 0 |
| | | timeout | |

4) Payload Size—the payload size field describes the number of data bytes in the payload (i.e., data) field (1 to 256).

5) Checksum—the checksum field provides an easily encoded and decoded error correction checksum for the control bits. As shown, the control field 30 begins after the SOF delimiter field and consists of the 16 bits that collectively make up the destination address field (4 bits), the packet type (4 bits) and the payload size (8 bits). If the checksum field indicates that any part of the destination address field and/or the packet type field and/or the payload size field is corrupt, the receiving node will discard the received packet. The type of error recovery performed is determined by the applications layer of the node sending the packet.

6) Payload Data Bits—a data packet can be up to 256 bytes in length (2048 bits). Whenever a control packet is to be transmitted, the payload data is zero bytes.

7) CRC16—If the payload field includes data, error correction is performed using a CRC-16 polynomial. A CRC failure results in a NAK response to the originating node.

8) End of Frame (EoF)—the End of Frame (EoF) packet consists of a unique hex number (e.g., 0×03) that is preferably selected based on its uniqueness from any of the remaining control or data bits by virtue of Base64 encoding.

Failure Recovery

Recovery from errors in the system is highly application dependent. For example, failure recovery from an actuation signal is different than failure recovery from imaging data. In the former case, the most expedient failure recovery may be to just throw out the data, while in the latter case, a retransmission is required.

The most likely mechanism for a failed packet is a CRC-16 failure. The CRC-16 field is described above and illustrated in FIG. 7. A failed CRC results in a NAK control packet (0×06) being issued from the receiving node to the sending node. The way in which the failure is handled is determined by the applications layer above the OWCM MAC layer. Upon receiving the NAK, the sending node may choose to retransmit the packet upon the next grant application or may otherwise choose to dump the data packet.

Another mechanism for a failed packet is a failed checksum. In the case of a failed checksum, the receiving node takes no action, the result of which is a timeout. For example, if a polled node receives a grant from the controller and responds by transmitting data to an intended receiving node, the polled node expects to receive either a NAK or ACK packet from the receiving node. If, however, the receiving node, fails the checksum, it takes no action. After a suitable timeout (e.g., an amount of time equivalent to the receiving node transmitting an ACK control packet) both the polled node and controller recognize the checksum failure and the controller transmits a grant packet to the next node on the grant list. Also, the polled node sends an appropriate communications failure message from the MAC to the polled node's applications software.

A third mechanism for a failed packet is a dead (silent) node. Silent nodes are ignored by the system. In the event a controller makes repeated attempts to transmit to a dead (silent) node, after a predetermined number of attempts, the controller will assume that the node is damaged and will no longer attempt to provide grants to the dead node. This frees up bandwidth for the remaining nodes in the network.

### EXAMPLE

Consider the case of a projectile (i.e., munition) being developed that has a requirement for 8 nodes. Four of the nodes are transmitting nodes and the remaining four nodes are receiving nodes. Each of the respective nodes are optically connected in accordance with a star/mesh network configuration. The four transmitting nodes comprise:
a first processor node (CTL1)
a second processor node (CTL2)
a processor (CTL3)
an imaging sensor (IMG1)

The four receiving nodes comprise:
a first actuator node (corresponding to the first processor node (CTL1)
a second actuator node (corresponding to the second processor node (CTL2)
Image processor
a guidance sub-processor

The two processor nodes, i.e., CTL1 and CTL2 are configured to send control data at a 5 kb/s data rate to their respective actuators. The processor, CTL3, is configured to send guidance information at 10 kb/s and the imaging sensor, IMG1, configured to send a 64×64 bit data array with a gray scale value of 8 bits at 10 frames/sec to an image processor. The imaging sensor, IMGI, thus sends data to the image processor at a rate of 327,680 bits/sec.

The system operates at a standard IrDA data rate of 4 MB/s. After initialization, the controller sends access grants to the respective transmitting nodes in accordance with a grant list determined apriori.
grant list=[CTL3, CTL1, CTL2, IMG1]
At each transmitting and receiving node, the data is buffered to meet the latency requirements of the system and to meet the natural generation rate of the transmitting node. For example, data is buffered at nodes CTL1, CTL2 and CTL3 in 8 bit increments, however, CTL3 transmits at a different rate than CTL1 and CTL2, i.e., CTL3 transmits every 0.8 ms as compared to every 1.6 ms for CTL1 and CTL2.

In general, the OWC network protocol satisfies the system requirements of the intended application by ensuring that the net effective data rate is met node-to-node communication and the latency of transmitted data is appropriate for the type of data being transmitted. As an example of satisfying these two requirements, CTRL1 and CTRL2 require data rates of 5 kb/s and the data being transmitted must arrive at the corresponding receiving nodes (i.e., the actuators) in a time interval consistent with controlling the actuators.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for communicating data in a network including a controlling node and a plurality of non-controlling nodes (I=1 to N), the method comprising:
(a) said controlling node sequentially polling each of said plurality of non-controlling nodes in said network to grant access to said network to allow a transfer of data to another one of said plurality of non-controlling nodes which may be stored at one or more of said plurality of non-controlling nodes;
(b) responding to said grant access at each of said plurality of non-controlling nodes with an indication of denial or acceptance;
(c) transmitting to another one of said plurality of non-controlling nodes, at least a portion of said data which may be stored at said one or more of said plurality of non-controlling nodes in the case where said response to said grant access at step (b) is acceptance; and
(d) repeating acts (a)-(c) in a cyclical manner.

2. The method according to claim 1, further comprising encapsulating said data which may be stored at one or more of said plurality of non-controlling nodes in one or more transport protocol data packets.

3. The method according to claim 2, wherein a quantity of data which may be stored in each of said one or more data packets is determined by a system data transfer rate parameter and a latency requirement of said network.

4. The method according to claim 1, wherein said step (a) of polling each of said plurality of non-controlling nodes is performed in a pre-defined polling order.

5. The method according to claim 4, wherein the pre-defined polling order may further include consecutive polling intervals allotted to particular ones of said plurality of non-controlling nodes.

6. The method according to claim 5, wherein a need for consecutive polling intervals allotted to said particular ones of said plurality of non-controlling nodes in said pre-defined polling order is determined as a function of a data transmission requirement of the particular non-controlling node and a latency requirement of said network.

7. The method according to claim 2, further comprising:
receiving at said another one of said plurality of non-controlling nodes, said one of said one or more of said transfer protocol data packets;
parsing said one of said one or more of said transfer protocol data packet to extract a destination address;
determining from said destination address if said another one of said plurality of non-controlling nodes is assigned an address matching said destination address;
processing certain fields of said one or more of said transfer protocol data packets in the case where said determination is true; and
otherwise discarding said packet.

8. The method according to claim 7, wherein the step of processing certain fields further comprises:
parsing a checksum field to extract a checksum value;
determining from said checksum value if said one of said one or more of said transfer protocol data packets is corrupt;
discarding said transfer protocol data packet in the case where said determination is not satisfied; and
sending a status message back to a node issuing said transfer protocol data packet indicating that said transfer protocol data packet is discarded.

9. The method according to claim 8, further comprising:
parsing a start-of-frame field to extract a start-of-frame parameter; and
performing a system timing alignment using said start-of-frame parameter.

10. In an optical wireless network environment supporting a data transmission protocol, said data transmission protocol comprising a physical layer and a media access control (MAC) layer, the MAC layer for creating optical wireless communication (OWC) packet structures in accordance with said data transmission protocol, for delivering said (OWC) packet structures to the physical layer for transmission over said network, and for processing said OWC packet structures received from the physical layer, the physical layer configured for receiving said (OWC) packet structures delivered from said MAC layer, for transmitting said (OWC) packet structures delivered from said MAC layer over said optical wireless network, for receiving said (OWC) packet structures received over said optical wireless network, and for delivering said (OWC) packet structures received over said optical wireless network to said MAC layer.

11. The data transmission protocol of claim 10, wherein said data transmission protocol is a low latency protocol.

12. The data transmission protocol of claim 10, including a broadcast node and a plurality of non-broadcast nodes, wherein said broadcast node is configured to:
(a) broadcast to the plurality of non-broadcast nodes; and
(b) create subnets for sub-groupings of nodes.

13. The system of claim 12, wherein each of said plurality of non-broadcast nodes includes a data buffer for storing data to be transmitted over said network, said data buffer being preferably sized in accordance with an estimated data transmission needs of said corresponding non-broadcast node.

14. The data transmission protocol of claim 10, including a controlling node and a plurality of non-controlling nodes, wherein said controlling node is configured to
(a) construct a grant list for determining a sequential order in which network access is provided to the plurality of non-controlling nodes; and
(b) grant said network access to the plurality of non-controlling nodes in a sequential order defined by said grant list to allow a transfer of data from one non-controlling node to another non-controlling node.

15. The data transmission protocol of claim 14, wherein the granting of said network access in a sequential order is repeated in a continuous manner.

16. The data transmission protocol of claim 14, wherein the controlling node is further configured to:
(a) divide a total available network bandwidth among the plurality of non-controlling nodes in dependence on each of said non-controlling nodes anticipated data transmission requirements; and
(b) establish a grant increment parameter value as an upper bound on an amount of data that may be transmitted by one of said non-controlling nodes in response to a grant access from said controlling node.

17. The data transmission protocol of claim 10, wherein the (OWC) packet structures comprise a plurality of packet fields including a start of frame field, a destination address field, a packet type field, a payload size field, a checksum field, a payload size field, a checksum field, a data field, a cyclic-redundancy field and an end-of-frame field.

18. The data transmission protocol of claim 10, wherein said MAC layer processes said OWC packet structures received from the physical layer by:
(1) determining from a destination address stored in said destination address field whether said received OWC packet structure is intended for a non-controlling node receiving said OWC packet structure; and
(2) processing a checksum stored in said checksum field to determine if one of said destination address and/or a packet type and/or a payload size is corrupt.

19. The system of claim 17, wherein said MAC layer further processes said OWC packet structures by:
(1) processing a start of frame data value stored in said start of frame field to enable said non-controlling node receiving said OWC packet structure to align its internal timing;
(2) processing a packet type data value stored in said packet type field to determine whether said packet type data value represents one of a control packet or a data packet; and
(3) extracting a payload size data value from said payload size field when it is determined that said packet type data value represents a data packet.
